(19) United States
(12) Patent Application Publication
(10) Pub. No.: US 2003/0158656 A1
(43) Pub. Date: Aug. 21, 2003

(54) Locating and controlling a remote device through a satellite location system

(76) Inventor: Zvi David, (US)

Correspondence Address: G. E. Ehrlich (1995) Ltd., c/o Anthony Castorina, Suite 207, 2001 Jefferson Davis Highway, Arlington, VA, 22202, US

(21) Appl. No.: 09/821,098

(22) Filed: Mar. 30, 2001

Related U.S. Application Data
(60) Provisional application No. 60/194,011, filed on Apr. 3, 2000.

(51) Int. Cl. G01C 21/26

(52) U.S. Cl. 701/208; 701/213

(57) ABSTRACT

A system and a method for enabling a remote device to be both located and controlled, with a remote ground transceiver and a satellite, even if the remote device is mobile, such as a vehicle for example. It should be noted that “control” also includes monitoring such communication. The method and system of the present invention are particularly preferred for security systems for movable objects, such as automobiles for example; management of a fleet of powered devices, such as ships, automobiles, trucks, motorcycles, bicycles and/or trains for example; and for telemetry applications, such as for remote asset command and control for example. Examples of such telemetry applications include, but are not limited to, oil or gas pipelines, remote storage tanks or buildings, and home security applications.

This Application claims priority from U.S. Provisional Application No. 60/194,011, filed on Apr. 3, 2000, which is currently pending and which is incorporated by reference as if fully set forth herein.

### FIELD AND BACKGROUND OF THE INVENTION

The present invention is of a method and a system for locating and controlling a remote device through a satellite location system, and more specifically, for such a method and system in which the remote device features a ground transceiver for communication, as well as a GPS (global positioning system) for determining the location of the remote device.

Automated technology has enabled equipment which is located in remote areas to be managed at a management station. Such automated technology includes sensors for detecting equipment malfunctions, security mechanisms against theft, and other monitoring devices for ensuring the proper function of the equipment without the presence of a human operator. These monitoring devices must be able to relay their findings to a management station, particularly in the case of an equipment malfunction such that an alarm would be required. Transceivers which are based on a communication through a satellite is often the best or even the only choice for enabling the remote equipment to communicate with the management station.

Such transceivers operate through wireless communication with the satellite, which then relays the communication to the intended recipient, such as the management system. For a remote device which is stationary, such a transceiver is sufficient in order for the intended recipient to be able to control the actions of the remote device. However, if the remote device is mobile, such as a vehicle of some type for example, the transceiver alone is not sufficient for controlling the remote device, since the location of the remote device is also important.

The ability to locate a remote device, even when such a device is actually moving, is provided with a GPS (global positioning system) device. The GPS device typically functions with a set of MEO (mid-earth orbit) satellites which have been launched for this purpose, and can relay the position of the remote device through coordination with a system of such satellites. However, GPS devices which are known in the art do not provide a mechanism for two-way communication with a management system or other controlling station through a LEO (low earth orbit) satellite. Other satellite systems can also be used for locating an object, depending upon the level of accuracy required. For example, even a single LEO satellite could be used to locate such an object through analysis of the Doppler effect for the signal.

A number of different systems and devices have been proposed for communication between a satellite and a ground device. For example, U.S. Pat. No. 5,664,006, incorporated by reference as if fully set forth herein, describes a system for connecting a user terminal device to a satellite and thence to a gateway. The gateway is then connected to a PSTN (public switched telephone network). As an additional example, U.S. Pat. No. 5,678,175, also incorporated by reference as if fully set forth herein, describes a system for communication with a plurality of satellites. Both of these examples contained detailed information about the frequency spectrum for communication between a ground transceiver and a low earth orbit satellite, orbiting at for example a 1414 km low earth orbit. However, neither example teaches or discloses a system for enabling a user to both locate and communicate with a ground device through a satellite, particularly for a LEO satellite.

There is therefore a need for, and it would be useful to have, a system and a method for both locating a remote ground device, and for communicating with such a ground device, through a satellite, such that a user could both locate and control a remote device which is mobile, such as a vehicle for example.

### SUMMARY OF THE INVENTION

The method and system of the present invention enable a remote device to be both located and controlled, with a remote ground transceiver and a satellite, even if the remote device is mobile, such as a vehicle for example. It should be noted that “control” also includes monitoring such communication. The method and system of the present invention are particularly preferred for security systems for movable objects, such as automobiles for example; management of a fleet of powered devices, such as ships, automobiles, trucks, motorcycles, bicycles and/or trains for example; and for telemetry applications, such as for remote asset command and control for example. Examples of such telemetry applications include, but are not limited to, oil or gas pipelines, remote storage tanks or buildings, and home security applications.

According to preferred embodiments of the present invention, the user is optionally and preferably able to control communication through a Web browser as an interface. The Web browser is connected to a Web server, which in turn is in communication with the satellite. Optionally, the Web server is able to communicate with the satellite through a ground station, although alternatively, communication is performed through a particular implementation of a ground transceiver.

According to the present invention, there is provided a system for communicating with, and determining a location of, a ground asset for a user, the system comprising: (a) a global location device for determining the location of the ground asset; (b) a ground asset transceiver located at the ground asset for transmitting the location of the ground asset in a message; (c) a satellite for receiving the message; and (d) a ground station for receiving the message from the satellite and for communicating the message to the user.

According to another embodiment of the present invention, there is provided a method for communicating with, and determining a location of, a ground asset for a user through a satellite, the method comprising the steps of: (a) determining a location of the ground asset; (b) sending the location in a message to the satellite; (c) transmitting the message from the satellite to a ground station; and (d) displaying the message to the user.

Hereinafter, the term “computing platform” refers to a computer hardware system or to a software operating system, and more preferably refers to a combination of computer hardware and the software operating system which is run by that hardware. Examples of particularly preferred computing platforms include, but are not limited to, embedded systems such as devices operated by Windows CE™(Microsoft Corp., USA) or DXworks™, as well as any embedded operating systems suitable for use with a satellite or other communications product.

For the implementation of the present invention, a software application could be written in substantially any suitable programming language, which could easily be selected by one of ordinary skill in the art. The programming language chosen should be compatible with the computing platform according to which the software application is executed. Examples of suitable programming languages include, but are not limited to, C, C++ and Java.

In addition, the present invention could also be implemented as firmware or hardware. Hereinafter, the term “firmware” is defined as any combination of software and hardware, such as software instructions permanently burnt onto a ROM (read-only memory) device. As hardware, the present invention could be implemented as substantially any type of chip or other electronic device capable of performing the functions described herein.

In any case, the present invention can be described as a plurality of instructions being executed by a data processor, in which the data processor is understood to be implemented according to whether the present invention is implemented as software, hardware or firmware.

### BRIEF DESCRIPTION OF THE DRAWINGS

The invention is herein described, by way of example only, with reference to the accompanying drawings, wherein:

FIG. 1 is a schematic block diagram showing an exemplary system according to the present invention;

FIG. 2 is a schematic block diagram showing an exemplary remote asset transceiver for use with the present invention; and

FIG. 3 is a flowchart of an exemplary method according to the present invention.

### DESCRIPTION OF THE PREFERRED EMBODIMENTS

The method and system of the present invention enable a remote device to be both located and controlled, with a remote ground transceiver and a satellite, even if the remote device is mobile, such as a vehicle for example. It should be noted that “control” also includes monitoring such communication. The method and system of the present invention are particularly preferred for security systems for movable objects, such as automobiles for example; management of a fleet of powered devices, such as ships, automobiles, trucks, motorcycles, bicycles and/or trains for example; and for telemetry applications, such as for remote asset command and control for example. Examples of such telemetry applications include, but are not limited to, oil or gas pipelines, remote storage tanks or buildings, and home security applications.

According to preferred embodiments of the present invention, the user is optionally and preferably able to control communication through a Web browser as an interface. The Web browser is connected to a Web server, which in turn is in communication with the satellite. Optionally, the Web server is able to communicate with the satellite through a ground station, although alternatively, communication is performed through a particular implementation of a ground transceiver via the satellite network's gateway station.

The principles and operation of a method and a system according to the present invention may be better understood with reference to the drawings and the accompanying description.

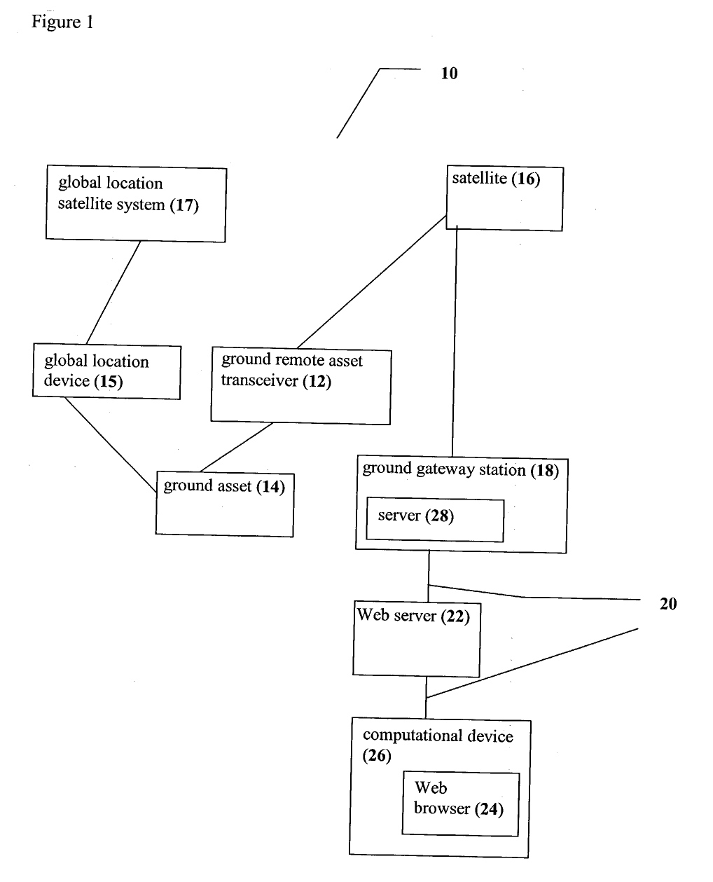

Referring now to the drawings, FIG. 1 shows a system 10 according to the present invention for communication between a ground asset and the user, as well as for providing the location of the ground asset to the user. As described in greater detail below, system 10 therefore has two general components: a first component for locating the ground asset, with the assistance of a GPS (global positioning system) or other global location device which communicates with a satellite; and a second component for two-way communication with the ground asset, provided through a ground transceiver and a satellite which is preferably in low earth orbit. The system for locating the ground asset and the system for communicating with a remote control center or user could optionally be the same satellite system, but preferably are two different satellite systems. The GPS satellite system could be employed, for example, for locating the ground asset. Other satellite systems can also be used for locating an object, depending upon the level of accuracy required. For example, even a single LEO satellite could be used to locate such an object through analysis of the Doppler effect for the signal.

More preferably, the user is able to receive the necessary information, such as the location of the ground asset, as well as to communicate with the ground asset, through a Web browser which is connected to a network such as the Internet for example.

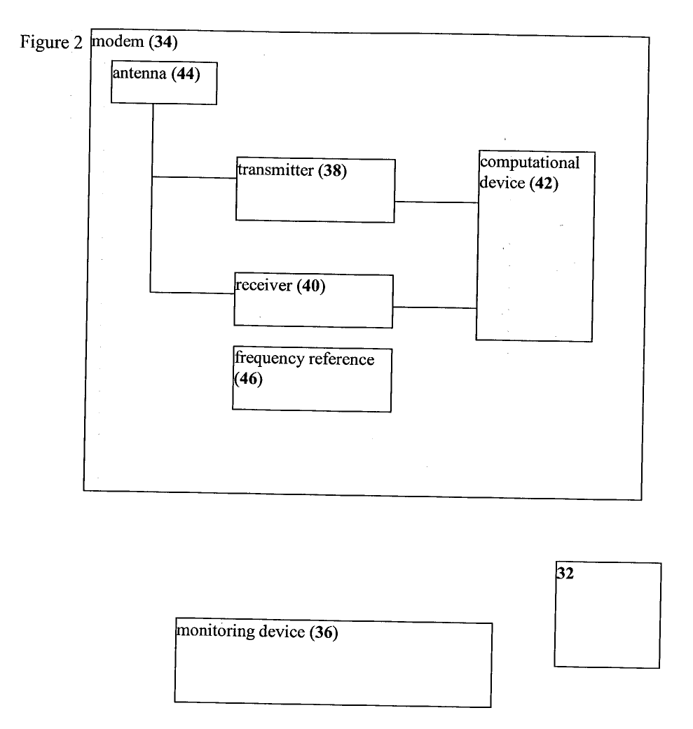

With regard to the communication component, system 10 features a ground remote asset transceiver 12 which is connected to a ground asset 14. Ground remote asset transceiver 12 is optionally and preferably constructed according to the illustration of FIG. 2. Ground remote asset transceiver 12 is in communication with a satellite 16, which is preferably in low earth orbit. Satellite 16 receives a communication from a ground remote asset transceiver 12 when ground remote asset transceiver 12 is within the “footprint” of satellite 16.

With regard to the location component of system 10, ground asset 14 also preferably features a global location device 15 which can be used to determine the location of ground asset 14. Global location device 15 communicates with a global location satellite system 17, in order for the position of ground asset 14 to be determined relative to global location satellite system 17.

Different embodiments of global location device 15 and global location satellite system 17 may be used. For example, both global location device 15 and global location satellite system 17 may be well known in the art, as the GPS system which was previously described and for which global location device 15 may optionally be purchased commercially from a number of different vendors. Other satellite systems can also be used for locating an object, depending upon the level of accuracy required. For example, even a single LEO satellite could be used to locate such an object through analysis of the Doppler effect for the signal.

As another example, geosensing may be used for global location device 15 and global location satellite system 17, in which global location device 15 is assigned a particular territory. If global location device 15 moves outside of this territory, global location device 15 causes an alarm to be sent through ground remote asset transceiver 12. Either of the previously described positioning systems may optionally be used for the geosensing application.

An example of the operation of system 10 is as follows. Global location device 15 communicates with global location satellite system 17 in order to determine the location of ground asset 14. This location information is then transmitted from ground asset 14 through ground remote asset transceiver 12. For example, ground remote asset transceiver 12 could attempt to contact satellite 16 to request a channel. Ground remote asset transceiver 12 could be any device which is capable of receiving and transmitting signals in the correct frequency spectrum, such as any device which features a RF modem for example, although ground remote asset transceiver 12 is implemented as described with regard to FIG. 2 below. The channel between ground remote asset transceiver 12 and satellite 16 is preferably determined according to a Time Division Multiple Access (TDMA) protocol, such that ground remote asset transceiver 12 would request a time slot for transmitting to satellite 16. However, the initial request from ground remote asset transceiver 12 is preferably sent according to a random access ALOHA protocol, which is an example of a contention protocol (for a description of ALOHA and its variants, see Tanenbaum A. S., Computer Networks, Prentice-Hall, 1996, pp. 121-124 for example).

Once satellite 16 receives the request, assuming that a collision does not occur between this request message and such a message from a different ground remote asset transceiver 12, satellite 16 assigns a particular time slot to ground remote asset transceiver 12. Ground remote asset transceiver 12 then transmits data to satellite 16. Satellite 16 then passes this communication to a ground gateway station 18 when ground gateway station 18 is within the “footprint” of satellite 16. Ground gateway station 18 also features a suitable transceiver device for receiving signals in the desired frequency range, such as a RF modem for example. Preferably, satellite 16 and ground gateway station 18 communicate according to a TDMA (Time Division Multiple Access) protocol, although other communication protocols could be used as is well known in the art, such as the CDMA (Code Division Multiple Access) protocol.

As its name suggests, ground gateway station 18 is a gateway for these messages from satellite 16 to the ground, and is connected to a ground communication network 20. For a preferred embodiment of system 10 according to the present invention, ground gateway station 18 passes the communication to a Web server 22 through ground communication network 20. The user can then interact with satellite 16, and hence with ground asset 14, through a Web browser 24 being operated by a computational device 26 which is connected to ground communication network 20. Alternatively, substantially any type of user interface could optionally be operated by the user in order to communicate with ground asset 14. The information which is sent from ground asset 14 includes the location of ground asset 14, as determined by global location device 15. Optionally and more preferably, ground asset 14 could automatically send an alarm if the location of ground asset 14 is not within an authorized area. Most preferably, the user is able to send a command to ground asset 14 to provide such location information, and/or to otherwise control the actions of ground asset 14, through the user interface such as Web browser 24.

Web server 22 optionally and preferably interacts with ground gateway station 18 as follows. Ground gateway station 18 is connected to Web server 22 through ground communication network 20, which is preferably a dedicated WAN (wide area network) or other dedicated network for this connection. Such a connection could optionally be implemented as a dedicated telephone data circuit, an ISDN connection (integrated system digital network), or microwave circuit, for example. The suitable transceiver device of ground gateway station 18 (not shown) receives the signals from satellite 16. These signals are then processed, for example as described in U.S. Pat. Nos. 5,664,006 and 5,678,175, incorporated by reference as if fully set forth herein. Ground gateway station 18 also contains suitable equipment for connection to ground communication network 20 (not shown), such as a router for example. Preferably, the communication protocol format used by ground gateway station 18 is a standard format, such as the X, 400 standard of the ITU (International Telecommunications Union).

More preferably, ground gateway station 18 also includes a server 28 which is capable of communicating according to the HTTP protocol. Alternatively, Web server 22 could replace server 28, such that Web server 22 would be located within ground gateway station 18. The signals which ground gateway station 18 receives from satellite 16 are therefore more preferably translated into HTTP data, which is transmitted from server 28 to Web server 22. Such a translation process optionally and preferably includes the steps of preparing a Web page from the received data.

Preferably, the user is also able to enter commands and/or instructions to ground asset 14 through Web browser 24, for example through a form served by Web server 22. For example, the user could request the current status and/or location of ground asset 14, or could send a command with regard to the behavior of ground asset 14. As an example of the latter type of command, if the user had determined that the location of ground asset 14 was incorrect, such as if ground asset 14 is a vehicle which is either moving or being moved out of an authorized area, the user could optionally and preferably send a command to ground asset 14 to cease operation. The commands and/or instructions would then be received by ground gateway station 18, and translated into a format which is suitable for transmission to ground asset 14 through satellite 16.

In addition, ground gateway station 18 also optionally performs authentication of Web server 22. However, Web server 22 preferably authenticates the user of Web browser 24, for example by requiring the user to enter a password or other identifier, such as a biometric measurement for example. An example of a biometric measurement is a fingerprint.

It should be noted that Web server 22 is an example of a communication server according to the present invention. Such a communication server could communicate with the user at the remote location through substantially any suitable network communication protocol, including but not limited to, HTTP and/or an e-mail protocol such as IMAP or SMTP for example. For communication through e-mail, Web browser 24 is optionally substituted by an e-mail software program, which could easily be selected from programs which are known in the art.

FIG. 2 is a schematic block diagram showing an exemplary ground remote asset transceiver according to a preferred embodiment of the present invention, implemented as part of the remote installation of the remote device (ground asset). As shown, a ground remote asset transceiver 32 features a RF modem 34, which could be a VHF modem for example. RF modem 34 is in communication with a monitoring device 36, preferably combined within the same housing as RF modem 34 to form a single unit. Monitoring device 36 monitors the function of at least one component of the remote installation (not shown). If a malfunction is detected, then monitoring device 36 sends a message to the central management station (not shown) through RF modem 34.

RF modem 34 could be implemented according to the modem disclosed in U.S. Pat. No. 5,666,648, for example, incorporated by reference as if fully set forth herein. In this implementation, RF modem 34 features a transceiver-satellite uplink transmitter 38, and a transceiver-satellite downlink receiver 40, for sending and receiving signals, respectively. Transceiver-satellite downlink receiver 40 receives the signals and downconverts, demodulates and decodes these signals. The received signals from transceiver-satellite downlink receiver 40 are processed by a computational device 42, which could be any of the previously disclosed computational platforms, for example. Computational device 42 optionally decrypts the message, for example.

In addition, computational device 42 also prepares the signal for transmission by transceiver-satellite uplink transmitter 38, for example optionally by encrypting the message. Transceiver-satellite uplink transmitter 38 then encodes and modulates the message from computational device 42, and then upconverts the signal to the channel frequency for transmission. Transceiver-satellite uplink transmitter 38 is connected to an antenna 44 for transmitting the data. Antenna 44 could be a normal-mode helix antenna such as those employed with portable VHF transceivers. All of the steps of processing of the signal itself which are performed by transceiver-satellite uplink transmitter 38 and transceiver-satellite downlink receiver 40 are performed with reference to a frequency reference 46.

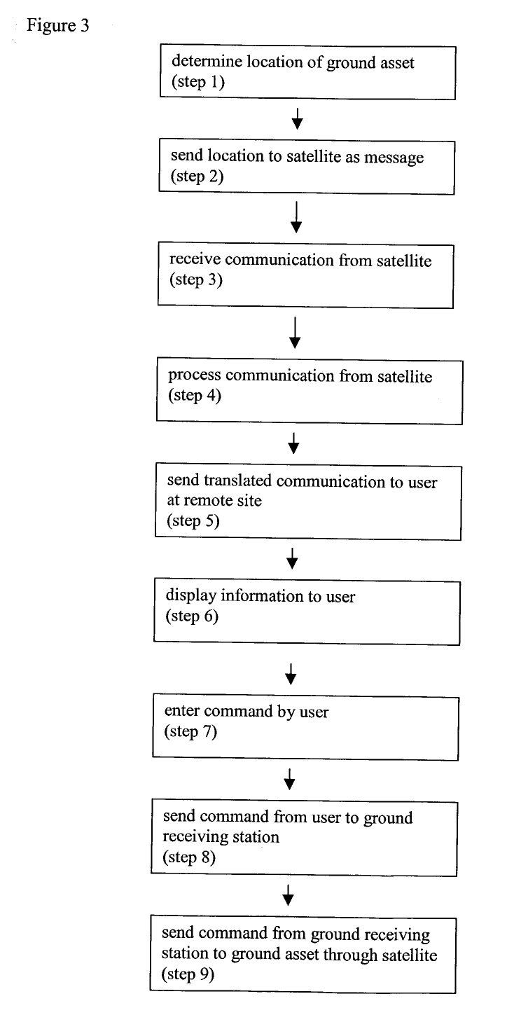

FIG. 3 is a flowchart of an exemplary method according to the present invention for locating a ground asset and for communicating with the ground asset through a satellite. For the purposes of explanation only and without any intention of being limiting, the network is assumed to be the Internet.

In step 1, the location of the ground asset is determined with a global location device and a global location satellite system. An example of such a global location device is a GPS device for operation with the GPS satellite system, as is well known in the art. As previously described, other types of satellite location systems could optionally be used, for example with a single LEO satellite for determining the location of a ground asset according to the Doppler effect.

In step 2, the ground asset transceiver sends a message to a satellite, which is preferably a LEO satellite. This message includes the location of the ground asset.

In step 3, a communication is received from the satellite by a suitable ground receiving station, such as the gateway of FIG. 1. In step 4, this ground receiving station processes the communication in order to translate the communication into a suitable network communication protocol format. For example, such a format could be HTTP. The communication from the satellite is preferably given in a particular format, such that certain types of data are contained within predefined data fields, for greater ease of translating the data.

In step 5, the translated communication is optionally and preferably sent to the user at the remote location. For example, if the translated communication features HTTP data, then preferably the remote location is operating a Web browser, and the HTTP data is sent from the ground receiving station by a Web server. Preferably, the user would be required to “log onto” the Web server by entering a password, or other identifying information, before any data could be sent or received.

In step 6, the translated communication is preferably displayed to the user, for example as a Web page. The data display may optionally include a textual message from the satellite. For example, if the user is communicating with a ground asset through the satellite, then the display may include information about the operation of the ground asset. Additionally, the display may include a map of the location of the ground asset, which is particularly useful for ground assets which are movable, such as various types of vehicles for example. Examples of different types of maps include, but are not limited to, scan map, vectorial map, air photo map and so forth.

Optionally and preferably, the user is also able to send commands and/or other instructions to the ground receiving station, and hence to the satellite, according to the suitable network communication protocol format. For example, the user could optionally and more preferably enter such instructions through a form which is displayed by the Web browser in step 7. The resultant data would then more preferably be sent to the ground receiving station in step 8. The ground receiving station would then optionally and more preferably pass the communication to the ground asset through the satellite in step 9. For example, the user could request the current operational status and/or location of the ground asset. The ground asset would then send a reply message to the user through the satellite as previously described.

It will be appreciated that the above descriptions are intended only to serve as examples, and that many other embodiments are possible within the spirit and the scope of the present invention.

What is claimed is:

1. A system for communicating with, and determining a location of, a ground asset for a user, the system comprising:
(a) a global location device for determining the location of the ground asset;
(b) a ground asset transceiver located at the ground asset for transmitting the location of the ground asset in a message;
(c) a satellite for receiving said message; and
d) a ground station for receiving said message from said satellite and for communicating said message to the user.

2. The system of claim 1, further comprising:
(e) a user interface for interacting with the user;
(f) a communication server for receiving communication from, and transmitting communication to, said user interface; and
(g) a network for connecting said communication server to said ground station.

3. The system of claim 2, wherein said satellite is in a low earth orbit.

4. The system of claim 2, wherein said user interface includes a Web browser, and said communication server is a Web server.

5. The system of claim 2, wherein the network is the Internet.

6. The system of claim 2, wherein the remote location is operating a e-mail software program, and said communication server is an e-mail server.

7. The system of claim 1, wherein said global location device is a GPS (global positioning system) device.

8. A method for communicating with, and determining a location of, a ground asset for a user through a satellite, the method comprising the steps of:
(a) determining a location of the ground asset;
(b) sending said location in a message to the satellite;
(c) transmitting said message from the satellite to a ground station; and
(d) displaying said message to the user.

9. The method of claim 8, wherein step (c) further comprises the steps of:
(i) translating said message into a network communication protocol for transmission on a network to form a translated message; and
(ii) sending said translated message to the user through said network.

10. The method of claim 9, wherein said network communication protocol is HTTP, such that said message is displayed by a Web browser.

11. The method of claim 9, wherein said network communication protocol is an e-mail protocol, such that said message is displayed by an e-mail software program.

12. The method of claim 9, wherein the network is the Internet.
